(19) United States
(12) Patent Application Publication
(10) Pub. No.: US 2009/0295099 A1
(43) Pub. Date: Dec. 3, 2009

(54) SLIDING SEAL

(76) Inventor: Brian Maxwell Hassen, Ardross (AU)

Correspondence Address: HOGAN & HARTSON LLP, ONE TABOR CENTER, SUITE 1500, 1200 SEVENTEENTH ST, DENVER, CO, 80202, US

(21) Appl. No.: 12/302,420

(22) PCT Filed: May 30, 2007
(86) PCT No.: PCT/AU07/00751

§ 371 Date: May 28, 2009

(30) Foreign Application Priority Data
May 30, 2006 (AU) 2006902903

(51) Int. Cl. F16J 15/32

(52) U.S. Cl. 277/565

(57) ABSTRACT

A sliding seal capable of operating effectively when encountering irregularities and changes in a surface against which it is working. The seal comprises plurality of resiliently flexible seal elements each having an outward extent including an outer portion terminating at a seal tip. At least some of the seal tips are offset with respect to other seal tips in the outward direction. The offset arrangement of the seal tips allows the seal to accommodate irregularities and changes in a surface against which the seal operates.

### FIELD OF THE INVENTION

The present invention relates to a seal, and more particularly to a seal for sliding or wiping movement against a surface to establish a fluid seal with respect to the surface and/or to apply a fluid substance to the surface.

The invention is particularly applicable to, but is not limited to, the in-situ rehabilitation of underground pipes and the apparatus for performing same.

### BACKGROUND ART

In the in-situ rehabilitation of pipes, a tool may be required to move along the interior of a pipe and a fluid substance (such as a resin, cement or other coating material) is applied to the inner surface of the pipe under pressure. A seal may be incorporated in the tool to contain the fluid substance and also apply it to the inner surface of the pipe. The inner surface of the pipe is often irregular and varying in diameter which can lead to leakage of the fluid substance passed the seal. Pipe joins are also subject to significant variation in the pipe diameter, thereby providing areas for potential leakage.

Examples of such a tool are disclosed in international applications PCT/AU01/00563 and PCT/AU03/01131, the contents of which are incorporated herein by way of reference. While the sliding seals utilised in the tools disclosed in the aforementioned applications have performed satisfactorily, the present invention seeks to provide a seal that can accommodate variations in the inner surface of the pipe more effectively or at least provide a useful alternative sealing arrangement.

### DISCLOSURE OF THE INVENTION

According to a first aspect of the present invention there is provided a seal comprising a plurality of flexible seal elements each mounted on a base and extending outwardly therefrom to terminate at a seal tip, at least some of the seal tips being offset with respect to other seal tips in the direction away from the base.

Preferably, the seal elements are disposed one adjacent another and each seal tip is offset with respect to an adjacent seal tip.

Preferably, the seal elements have outer portions defining the seal tips, the outer portions being in spaced apart relation to define gaps therebetween.

The seal elements may be disposed one adjacent another in abutting relation.

Each seal element may comprise an inner portion around which the outer portion is disposed, the inner portion being thicker than the outer portion, whereby said gaps are defined between the radially outer portions of adjacent disks when the inner portions thereof are in abutting relation.

Each seal element may comprise two side faces and an outer face defining the seal tip.

Each seal tip may be profiled to present a sealing edge. In a preferred arrangement, the outer face of the seal element is chamfered to define the sealing edge at the junction between the outer face and one of the side faces.

The sealing edge is preferably at the side of the seal element which leads upon movement of the seal relative to the surface.

Preferably, the plurality of seal elements comprise two end seal elements and one or more intermediate seal elements therebetween, one end seal element having the tip thereof spaced furthest from the base, the other end seal elements having the tip thereof spaced closest to the base, and the intermediate seal elements being progressively offset therebetween.

In one form of the invention, each seal tip extends around the periphery of the seal element. In this form of the invention, each seal tip may be generally circular, in which case the offsetting between the seal tips is provided by the seal tips being of different diameters. This form of the invention is appropriate for sealing against cylindrical surfaces such as the inner walls of pipes. With this arrangement, the seal can continue to operate effectively when irregularities and changes in internal diameter of the pipe are encountered. More particularly, the seal is composed of a plurality of flexible seal elements of gradually increasing diameters which separately are able to operate effectively over a narrow range of pipe diameters. However, when operating as a combined set, the seal is able to accommodate significant changes in the diameter of the pipe since there is always one of the individual seal elements that can be effective in sealing engagement. In this manner the leakage of fluid substance past the seal is minimised in even the most irregular of pipes and badly completed pipe joins.

In another form of the invention, each seal tip may be generally planer. This form of the invention is appropriate for sealing against a substantially flat surface.

The seal elements are flexible at least at the outer portion thereof adjacent the seal tip. However, the seal elements may be flexible throughout. Typically, this would be achieved by forming the seal elements from appropriate flexible material.

The seal elements are preferably resiliently flexible. The seal elements may, for example, be formed from polyurethane.

The seal elements may be discrete elements mounted on the base or they may be formed integrally with the base.

The base may simply support the seal elements or alternatively may be adapted to bias the seal elements towards the surface. In the latter case, the base may be selectively displaceable for urging the seal elements towards the surface. In this regard, the base may comprise a wall on which the seal elements are supported, the wall being adapted for deflection in response to fluid pressure. In this regard, the wall may be operably coupled to a bladder structure adapted to receive an inflation fluid such as air for deflecting the wall.

In use, each seal element in sliding engagement with the surface deflects laterally at its outer end adjacent the seal tip in a direction opposite to the direction of movement of the seal element relative to the surface. In other words, the seal element deflects in a direction away from the direction of relative movement of the seal. In referring to relative movement between the seal and the surface, it should be understood that either one of the seal or the surface can move while the other is stationary, or alternatively both the seal and the surface can move but at different speeds or in opposite directions.

According to a second aspect of the present invention there is provided a seal comprising a plurality of flexible seal elements each having an outward extent terminating at a seal tip, at least some of the seal tips being offset with respect to other seal tips in the outward direction.

According to a third aspect of the present invention there is provided a seal comprising a plurality of flexible seal elements in abutting relation, each seal element having an outward extent terminating at a seal tip, at least some of the seal tips being offset with respect to other seal tips in the outward direction, each seal element comprising an inner portion, an outer portion defining the seal tip, the inner portion of each seal element being thicker than the outer portion thereof, whereby gaps are defined between outer portions of adjacent seal elements.

### BRIEF DESCRIPTION OF THE DRAWINGS

Preferred embodiments of the invention will now be described, by way of example only, with reference to the accompanying drawings in which:

FIG. 1 is a schematic side elevational view of a tool for lining the inner wall of a pipeline, the tool incorporating a seal according to a first embodiment of the present invention;

FIG. 2 is a schematic front elevational view of the tool;

FIG. 3 is a schematic fragmentary side elevational view of the tool showing the seal on an enlarged scale;

FIG. 4 is a schematic sectional side view of the tool operating in a section of a pipeline;

FIG. 5 is a schematic fragmentary side view of the arrangement of FIG. 4 showing the seal on an enlarged scale;

FIG. 6 is a schematic sectional side view of the tool operating in a further section of the pipeline of reduced diameter compared to that shown in FIG. 4;

FIG. 7 is a schematic fragmentary side view of the arrangement of FIG. 6 showing the seal on an enlarged scale;

FIG. 8 is a schematic sectional side view of the tool operating in a still further section of the pipeline at which there is a pipe junction;

FIG. 9 is a schematic fragmentary side view of the arrangement of FIG. 8 showing the seal on an enlarged scale; and

FIG. 10 is a schematic sectional view of a seal according to a second embodiment of the invention.

### DESCRIPTION OF PREFERRED EMBODIMENT

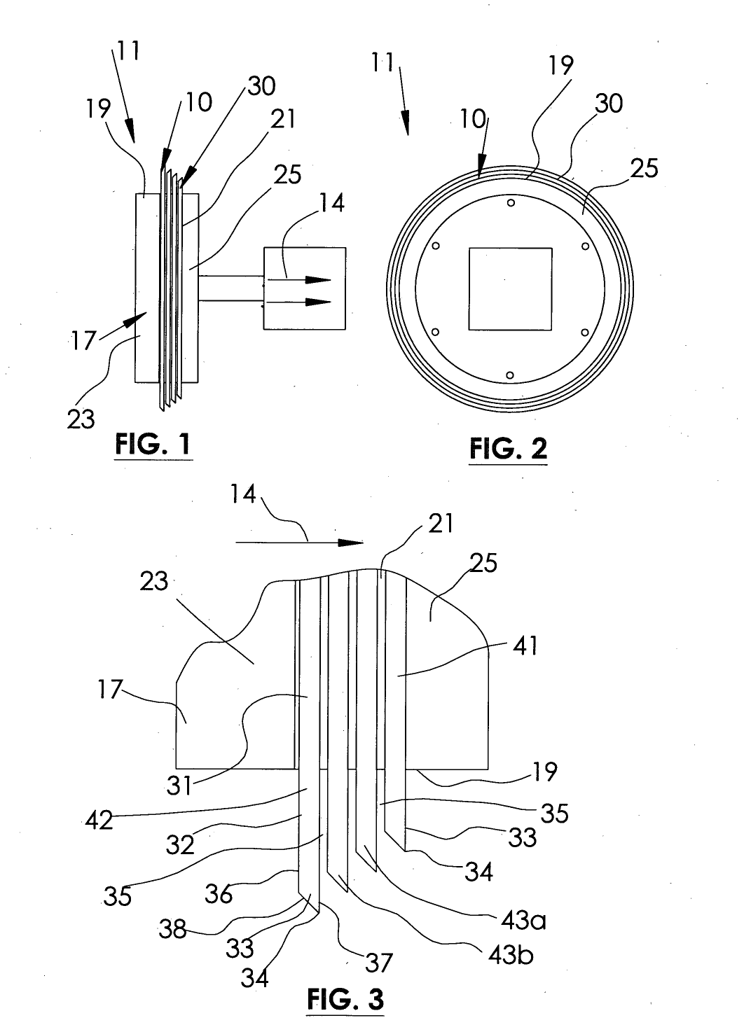

Referring to FIGS. 1 to 9 of the drawings, there is shown a seal 10 according to the embodiment fitted to a tool 11 for lining a pipeline 13. The lining operation involves application of a fluid (substance to the inner surface 15 of the pipeline 13. Examples of such a tool, as well as a lining operation performed by the tool, are disclosed in international applications PCT/AU01/00563 and PCT/AU03/01131, the contents of which are incorporated herein by way of reference. In those examples, the fluid substance comprises a viscous fluid substance which comprises resin in some instances and grout (cement) in other instances. The fluid substance may, however, be of any appropriate type.

The tool 11 is adapted to move along the pipeline 13 in a direction depicted by arrows identified by reference numeral 14 in FIGS. 1 and 3.

The seal 10 confines the fluid substance as well as acting to wipe the fluid substance onto the inner surface 15 of the pipeline. Furthermore, the seal 10 contains fluid pressure acting on the seal in the pipeline.

The seal 10 is accommodated in a body 17 forming part of the tool 11. The body 17 has an outer periphery 19 and a space 21 which is defined between two sections 23, 25 of the body and in which the seal 10 is accommodated to project beyond the outer periphery 19. In this way, the body 17 provides a base to support the seal 10.

The seal 10 comprises a plurality of resiliently flexible seal elements 30 disposed one adjacent another in abutting relation and clamped between the two sections 23, 25 of the body 17. Each seal element 30 is configured as a disk having a radially inner portion 31, and a radially outer portion 32 which extends beyond the outer periphery 19 of the body 17 and terminates at a seal tip 33 which defines a sealing edge 34. With this arrangement, each seal element 30 has a radially outward extent, terminating at the seal tip 33. The radially outer portions 32 are in spaced apart relationship to define gaps 35 therebetween. The gaps 35 accommodate lateral deflection of the outer portions 32 of the seal elements 30, as will become apparent later.

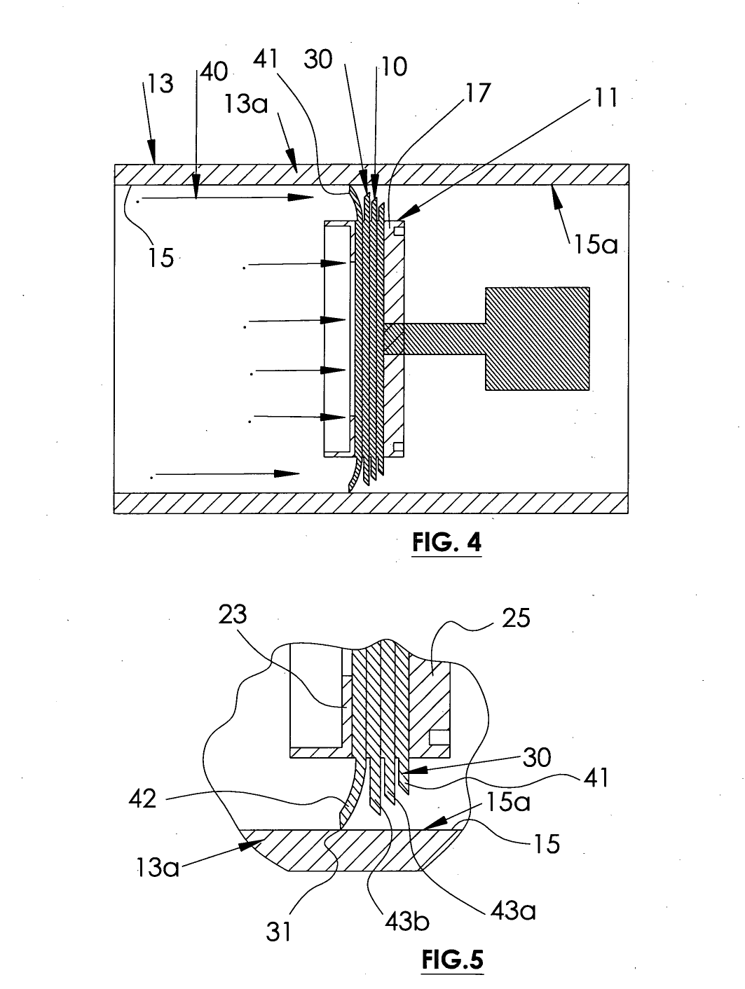

In the arrangement shown, each disk 30 comprises two side faces 36, 37 and a radially outer face 38. The outer face 38 is chamfered to define the sealing edge 34 at the junction between the outer face and one side face 37. As can be seen in the drawings, the sealing edge 34 is at that side of the seal element which leads upon movement of the seal 10 relative to the inner surface 15 of the pipeline. In this way, the seal element 30 (when contacting the inner surface 15) can continue to present the sealing edge 34 to the surface 15 as the seal element deflects laterally upon relative movement to the surface 15 (the lateral defection being in a rearward direction opposite to the direction of movement of the tool 11), as shown in FIGS. 4 to 9.

The radially inner portion 31 of each disk 30 is thicker than the radially outer potion 31 such that the gaps 35 are defined between the radially outer portions of adjacent disks. The difference in thickness between the radially inner and outer portions 31, 32 is accommodated by a step 39 in side face 36 defining the intersection of the radially inner and outer.

In an alternative arrangement (not shown), the disks 30 may be of uniform thickness with spacers therebetween to form the gaps 35.

The seal elements 30 comprise two end seal elements 41, 42 each adjacent one of the two sections 23, 25 of the body 17, and a plurality of intermediate seal elements 43.

The seal tips 33 of the seal elements 30 are of various diameters, progressively increasing from the smallest diameter at end seal element 41 to the largest diameter at the at end seal element 42. In this way, the seal tip 33 of each seal element 30 is offset with respect to the seal tip 33 of the immediately adjacent seal element.

FIGS. 4 and 5 show the seal 10 confined inside a section 13a of the pipeline 13. In this situation, the largest diameter seal element 42 is in sliding engagement with the inner surface 15a of the pipeline section 13a and is providing a sealing function. Because of the contact with the inner surface and movement of the tool along the pipeline, the radially outer portion 32 resiliently deflects laterally in a direction away from the direction of movement of the tool 11 and the seal 10. The end seal element 42 is operating at maximum efficiency and the other seal elements, which each are of a smaller diameter than seal element 42, are not performing any part in the sealing process Fluid pressure in the pipeline 13 acting on the seal 10 (as depicted by arrows 40 in FIG. 4) is contained by the seal provided by the seal element 42.

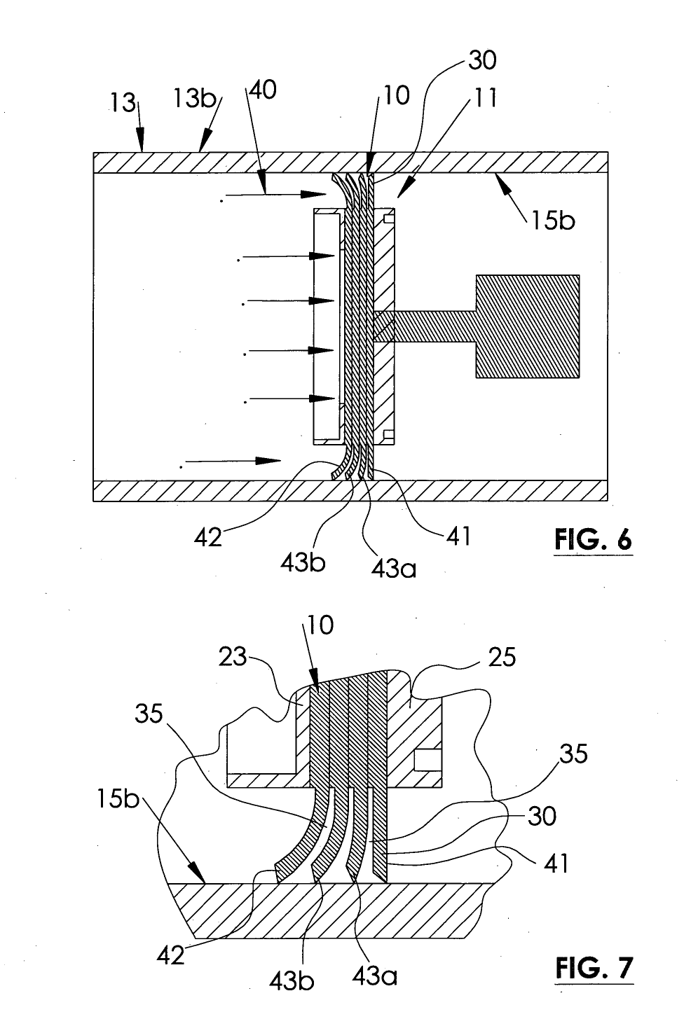

FIGS. 6 and 7 show the seal 10 confined inside a section 13b of the pipeline 13 of smaller diameter than the pipeline section 13a referred to previously. In this situation, the smaller diameter end seal element 41 and the intermediate seal element 43a adjacent thereto are in sliding engagement with the inner surface 15b of the pipeline section 13b and are providing a sealing function. The larger diameter intermediate seal element 43b, as well as the larger end seal element 42, have undergone deflection to accommodate the reduction in diameter within the pipeline and are not required to perform an effective sealing function, although they may be of some assistance in doing so. Fluid pressure in the pipeline section 13b acting on the seal 10 (as depicted by arrows 40 in FIG. 6) is contained by the seal provided by the seal element 41.

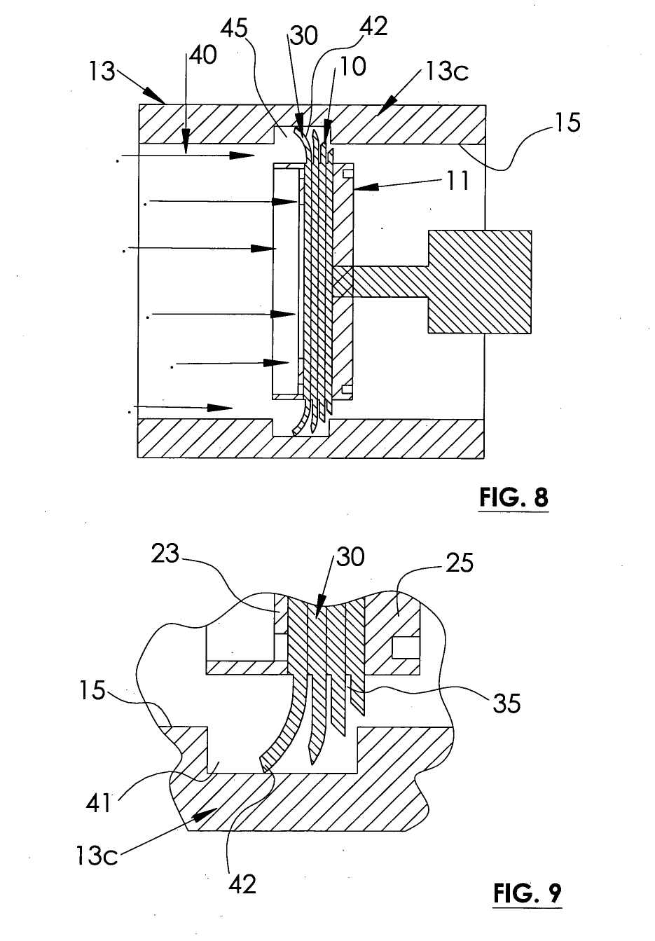

FIGS. 8 and 9 show the seal 10 confined inside a section 13c of the pipeline incorporating a junction 45 at which there is a significant change in the pipe diameter for a short distance. The smaller diameter seal elements 41, 43a and 43b cease to be effective whilst passing over the pipe junction 45, but the larger diameter seal element 42 becomes effective as the pipe diameter increases for the duration of the junction 45. 1. As the seal 10 moves beyond the junction 45, the smaller diameter seal-elements again become effective as the pipe diameter returns to its average size. Fluid pressure in the pipeline section 13c acting on the seal 10 (as depicted by arrows 40 in FIG. 5) is contained by the seal provided by the smaller diameter seal elements whist the seal is not at the pipe junction 45 and by the larger diameter seal element 42 whilst the seal is positioned at the junction 45.

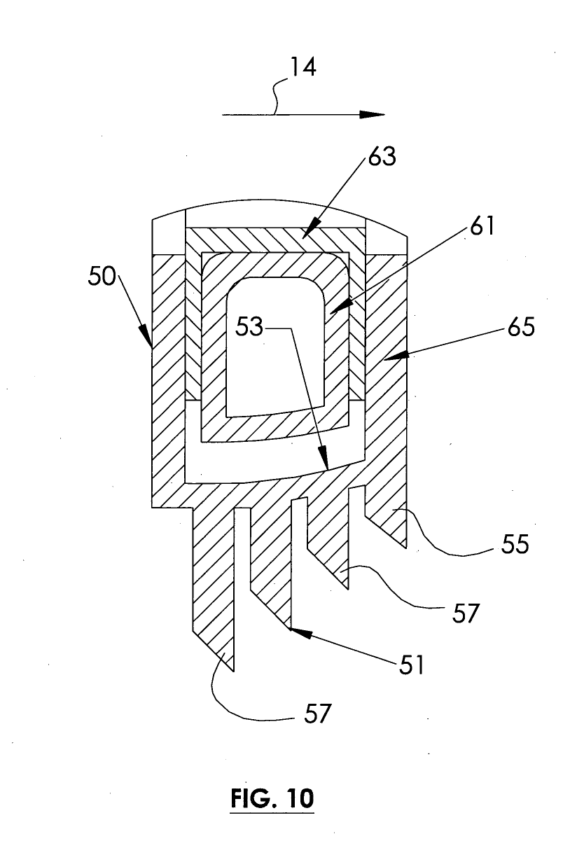

Referring now to FIG. 10 there is shown a seal 50 according to a second embodiment.

The seal 50 comprises a plurality of resiliently flexible seal elements 51 which are adapted to operate in a somewhat similar manner to the seal elements 30 of the first embodiment in performing a sealing function. The seal elements 51 are mounted on a flexible base 53 and are configured as annular fins 55 formed integrally with the base. As with the first embodiment, the seal elements 51 terminate at seal tips 57 of various diameters.

A bladder structure 61 is positioned adjacent the base 53 on the opposed side thereof to the fins 55. The bladder structure 61 is accommodated in a rigid cradle 63 to which the base 53 is rigidly attached by side flanges 65. With this arrangement, inflation of the bladder structure can cause outward displacement of the base 53 thereby urging the fins 55 into contact with the surface (not shown) against which the seal 50 is to perform a sealing function.

From the foregoing it is evident that the present embodiments each provide a simple yet highly effective seal capable of operating effectively when irregularities and changes in diameter of a pipeline encountered.

It should be appreciated that the scope of the invention is not limited to the scope of the two embodiments described. The seal according to the invention may have application in areas other than pipelines and may be used to contain any appropriate fluid substance including liquids and gases.

Modifications and changes can be made without deporting from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A seal comprising a plurality of flexible seal elements each mounted on a base and extending outwardly therefrom to terminate at a seal tip, at least some of the seal tips being offset with respect to other seal tips in the direction away from the base.

2. A seal according to claim 1 wherein the seal elements are disposed one adjacent another and each seal tip is offset with respect to an adjacent seal tip.

3. A seal according to claim 1 wherein the seal elements have outer portions defining the seal tips, the outer portions being in spaced apart relation to define gaps therebetween.

4. A seal according to claim 1 wherein each seal element comprises two side faces and an outer face defining the seal tip.

5. A seal according to claim 4 wherein each seal tip is profiled to present a sealing edge.

6. A seal according to claim 1 wherein the plurality of seal elements comprise two end seal elements and one or more intermediate seal elements therebetween, one end seal element having the tip thereof spaced furthest from the base, the other end seal elements having the tip thereof spaced closest to the base, and the intermediate seal elements being progressively offset therebetween.

7. A seal according to claim 1 wherein the base is selectively displaceable for urging the seal elements towards a surface.

8. A seal according to claim 7 wherein the base comprises a wall supporting the seal elements, the wall being adapted for deflection in response to fluid pressure.

9. A seal according to claim 1 wherein the seal elements are resiliently flexible.

10. A seal comprising a plurality of resiliently flexible seal elements, each having an outward extent terminating at a seal tip, at least some of the seal tips being offset with respect to other seal tips in the outward direction.

11. A seal according to claim 10, wherein said plurality of resiliently flexible seal elements are in abutting relation, each seal element comprising an inner portion, an outer portion defining the seal tip, the inner portion of each seal element being thicker than the outer portion thereof, whereby gaps are defined between outer portions of adjacent seal elements.
